(19) United States
(12) Patent Application Publication
(10) Pub. No.: US 2001/0006733 A1
(43) Pub. Date: Jul. 5, 2001

(54) Method and apparatus for forming coating

(76) Inventors: Masato Sagawa, Nishikyo-ku (JP); Osamu Itatani, Nishikyo-ku (JP)

Correspondence Address: Barry E. Bretschneider, Morrison & Foerster LLP, 2000 Pennsylvania Avenue, N.W., Washington, DC, 20006-1888, US

(21) Appl. No.: 09/725,482

(22) Filed: Nov. 30, 2000

(30) Foreign Application Priority Data
Dec. 2, 1999 (JP) H11-343016

(51) Int. Cl. B32B 17/10; B05D 3/02

(52) U.S. Cl. 428/429; 428/447; 427/344

(57) ABSTRACT

Constitution: Impact media m to which a powder is attached impinge an article 19 with an adhesive layer formed thereon so that the powder adheres to the surface of the article, in which the impact media comprises a magnetic material and are subject to a magnetic field.

Effect: Even if the article to be coated has small or deep holes or acute corners and some of the impact media are caught in such holes or corners, the captured particles of the impact media can be attracted by the magnetic force of impact media particles adjoining the captured impact media particles so as to be ejected from such holes and corners. The impact media are thus prevented from being caught in small or deep holes or acute corners formed in an article, whereby the problem that conventional methods suffer can be remedied.

### FIELD OF THE INVENTION

The present invention relates to a method and an apparatus for forming a powder coating on surfaces of various articles or parts (herein after simply referred to as the “article”) used in various industrial fields.

### PRIOR ART

The present applicant has presented in prior art disclosed by the present applicant, Japanese Patent Kokai Nos. H5-302176, H6-154698, H7-136577 and H7-195026 methods and apparatuses for forming a powder coating in which an adhesive layer is formed on a surface of an article, and the article having the adhesive layer thereon is impinged by impact media so that powder existing in portions subject to collision between the impact media and the article is buried into or bonded to the adhesive layer of the article.

In the coating methods and apparatuses described above, if the article has small or deep holes, acute corners, or narrow clearances, the impact media tend to be caught in such holes, corners or narrow clearances, and can not be ejected from them. When the impact media being caught in such a manner are eliminated after formation of a coating, the resultant coating is often defective and the elimination process takes time and labor, leading to an increase in the cost for coating formation.

When adopting the above mentioned methods or apparatus to form a coating on an article with a large area such as cases for electronic devices, since devices for applying vibration or agitation to the article or the impact media need to be large-scaled, the necessary amount of the impact media elevates by far, and also loss of the powder for the coating formation increases. In addition, it is difficult to produce an automated apparatus for efficiently implementing such a coating method for articles with a large area.

Accordingly, it is an object of the present invention to overcome such problems in the conventional methods and apparatuses as described above.

In order to achieve the object stated above, the present invention firstly provides a method for forming a coating in which an article being provided with an adhesive layer thereon is subjected to impingement by an impact material for the coating formation (hereinafter referred to as the “impact media”) to which a powder is applied so as to firmly bond the powder to the surface of the article, characterized in that the impact media comprises a magnetic material are subjected to a magnetic field. The present invention secondly provides the method for forming a coating described above in which the impact media comprising a magnetic material form a magnetic brush. The present invention thirdly provides an apparatus for forming a coating comprising an article provided with an adhesive layer, impact media comprising a magnetic material to which a powder is applied, means for moving either one or both of the article and the impact media, and means for applying a magnetic field to the impact media.

### BRIEF DESCRIPTION OF THE DRAWINGS

FIG. 1 is a perspective illustration of a coating apparatus for carrying out the method of this invention.

FIG. 2 illustrates partially in perspective the coating apparatus in FIG. 1 being partially cutaway.

FIG. 3 is an exploded view in perspective of a portion including magnet-holding frames constituting the coating apparatus in FIG. 1.

FIG. 4 is a perspective view of a portion including an impact media storing box constituting the coating apparatus in FIG. 1.

FIG. 5 is a perspective view partially in vertical cross section of the coating apparatus in FIG. 1.

FIG. 6 is an exploded view in perspective of a part including a lid constituting the coating apparatus in FIG. 1 being partially cut away.

FIG. 7 is a vertical sectional view in the direction transverse to the rails of the coating apparatus in FIG. 1.

FIG. 8 is an elevational view of the coating apparatus in FIG. 1.

FIG. 9 illustrates in elevation a partial cross sectional view of another embodiment of a coating apparatus carrying out the method of this invention.

FIG. 10 is a partial cross sectional view in side elevation of the coating apparatus in FIG. 9.

FIG. 11 is a vertical sectional view of a still another embodiment of a coating apparatus carrying out the method of this invention.

FIG. 12 is a vertical sectional view of a further modified embodiment of a coating apparatus carrying out the method of this invention.

### DETAILED DESCRIPTION OF THE PREFERRED EMBODIMENT

Preferred embodiments of the present invention are hereinafter described. However, they are not limited to the following embodiments, and may be modified within the scope and spirit of this invention.

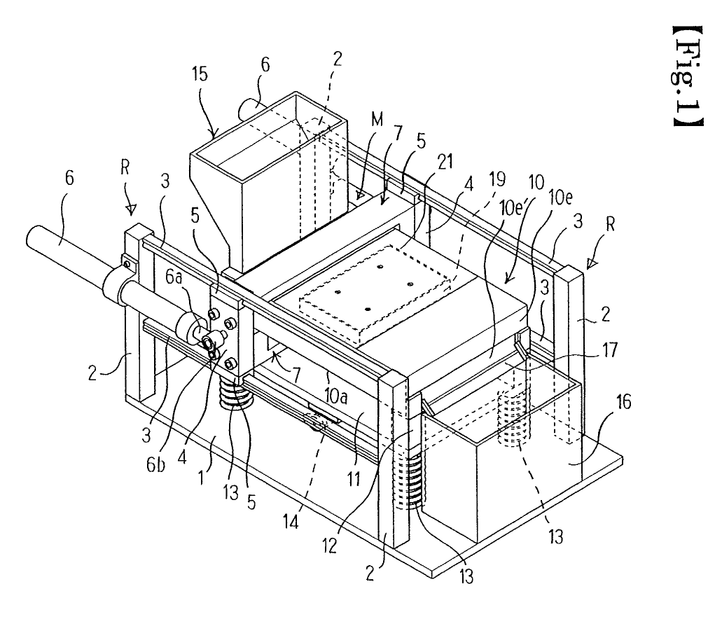

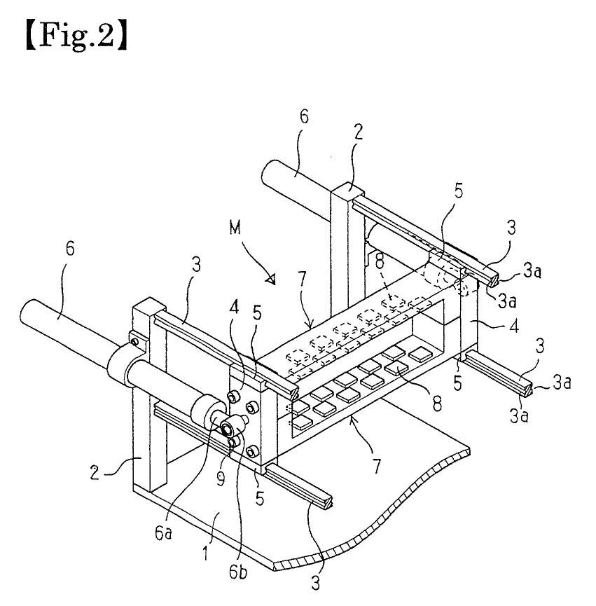

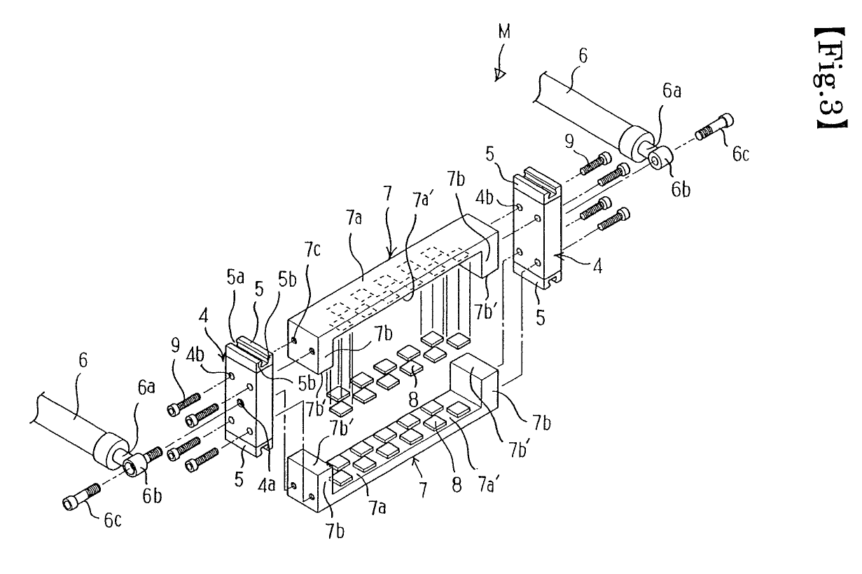

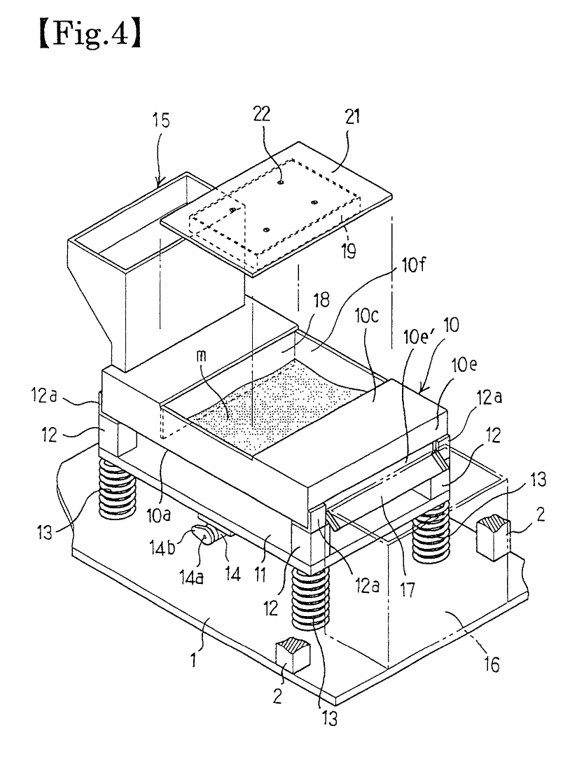

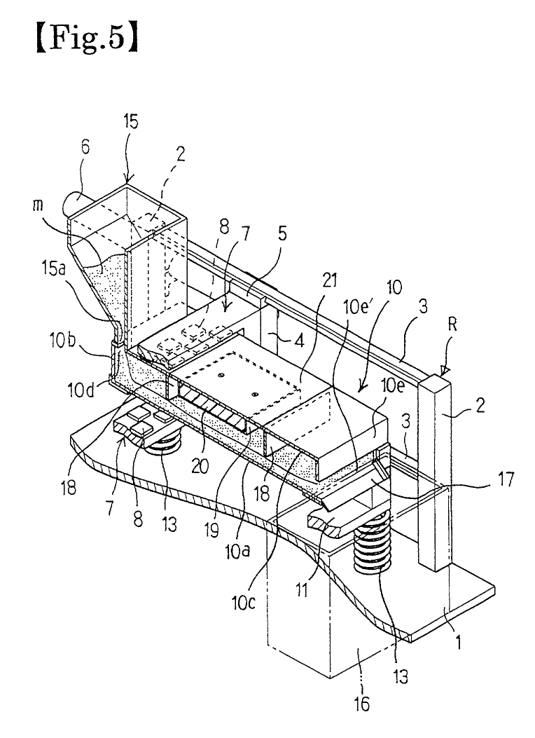

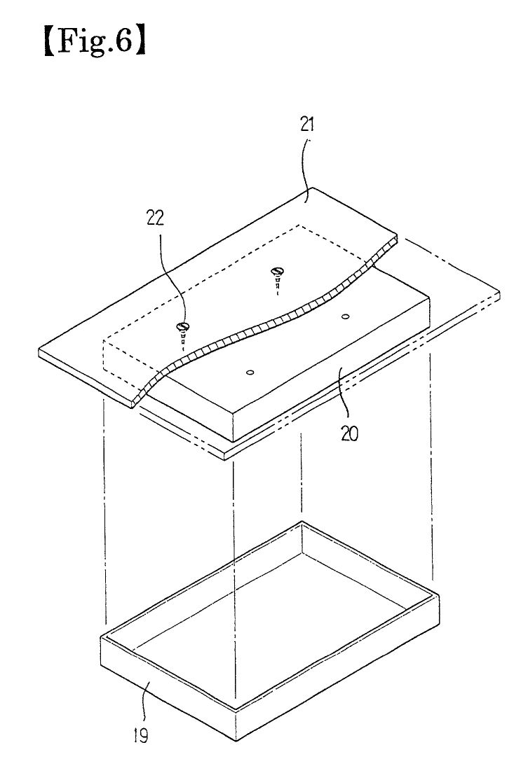

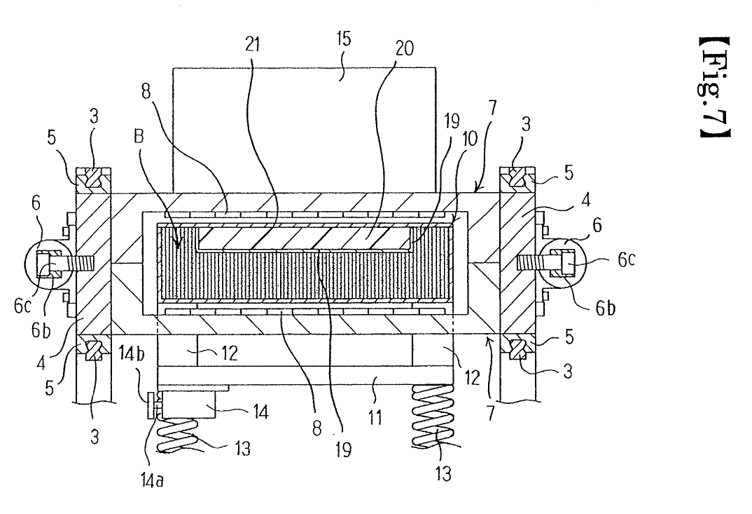

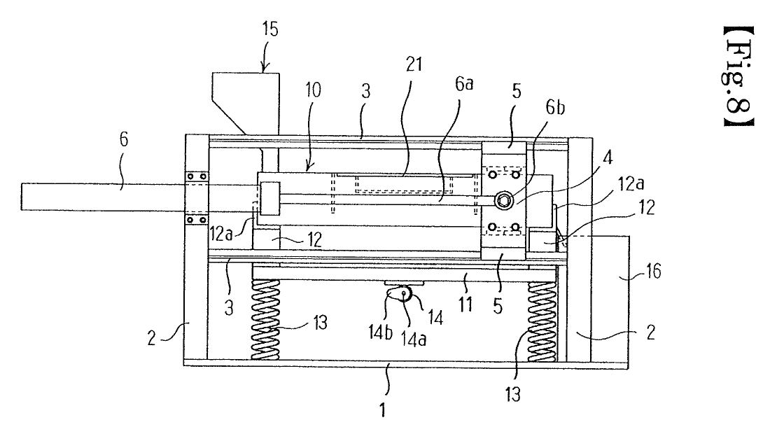

Referring to FIGS. 1 through 8, the method and apparatus of the present invention are now described.

A rail support member R consists of a pair of support pillars 2 arranged in a standing manner on a base 1, and a pair of rails 3 attached to the support pillars being arranged horizontally and in parallel at a prescribed interval. Recessed grooves 3a are formed in the longitudinal side surfaces of the rails 3 facing each other. Two rail support members R constructed as above are arranged in parallel with a prescribed distance in between.

Rail engagement blocks 5 are mounted on upper and bottom surfaces of a slidable block 4. The rail engagement block 5 is provided with a recessed portion 5a whose upper internal surfaces facing each other have projected lines 5b formed in a protruding manner so that the projected lines 5b fit into the grooves 3a when the rail 3 is inserted into the recessed portion 5a.

A cylinder 6 is mounted horizontally on the support pillar 2 constituting the rail support member R. A volt 6c is inserted into a cylindrical body 6b attached to the end of a piston rod 6a of the cylinder 6, and the end part of the volt 6c is screwed into a threaded hole 4a drilled in the slidable block 4 so that the piston rod 6a is pivotally connected to the slidable block 4.

A magnet-holding frame 7 formed integrally from a magnetic material comprises a horizontal rectangular portion 7a and vertical portions 7b extending vertically from the horizontal portion 7a. A pair of magnetic frames 7 constructed as such are arranged opposite to each other so that the end surfaces 7b of the vertical portions 7b abut against each other.

A plate-shaped magnet pieces 8 are attached to a surface 7a opposite to the horizontal portion 7a of the magnet-holding frame 7 a pair of which is arranged opposite so that the end surfaces 7b of the vertical portions 7b abut against each other. The magnet pieces 8 attached to the magnet-holding frames 7 are arranged in a zigzag form in which the magnetic poles of the magnetic pieces in the upper and lower frames are oriented in the same direction so that the magnetic poles of the magnet piece surfaces facing each other are opposite to each other. For example, if the bottom surface of the magnet piece 8 attached to the upper magnet-holding frame 7 is magnetized with a N pole while the upper surface of the magnet piece 8 attached to the surface 7a of the horizontal portion 7a being magnetized with a S pole, the magnet piece 8 attached to the lower magnet-holding frame 7 has a S pole in the upper surface and a N pole in the bottom surface attached to the surface 7a of the horizontal portion 7a. Additionally, the magnet pieces 8 attached to the upper and lower magnet-holding frames are arranged plane-symmetrically. The magnet-holding frames having the structure above are connected to the slidable blocks 4 by inserting volts 9 into horizontal holes 4b drilled in the slidable blocks 4 and also inserting them into threaded holes 7c provided in the vertical portions 7b of the magnet-holding frames 7 so that the end surfaces 7b of the vertical portions 7b are abutted against each other.

A magnet reciprocation device M intended for reciprocating the pair of magnet-holding frames provided with magnet pieces 8 along the rails 3 consists essentially of the rail support members R, the slidable blocks 4, the rail engagement blocks 5, the cylinders 6 and the magnet-holding frames 7 provided with the magnet pieces 8. The pair of magnet-holding frames 7 with the magnet pieces 8 whose magnetic poles are arranged opposite to those in the facing magnet surfaces reciprocate along the rails 3 by driving the cylinders 6 so as to move the piston rods 6a back and forth.

A impact media storing box 10 is mounted through L-shaped edge supports 12a on the upper ends of support blocks 12 stood on four corners of a support board 11. Between the bottom board of the impact media storing box 10 and the support board 11, a space is formed with a size such that the magnet-holding frames 7 constituting the magnet reciprocation device M are allowed to pass. Coil springs 13 are disposed at the four corners of the bottom surface of the support board 11, and the impact media storing box 10 is disposed above the support board 11 and connected thereto through the coil springs 13. A motor 14 having an eccentric weight 14b mounted on a power shaft 14a is attached to the bottom surface of the support board 11.

An end portion of a top plate 10c of the impact media storing box located in the vicinity of a side board 10b disposed vertically to the reciprocating direction of the magnet-holding frames 7 is provided with a long and narrow opening 10d. A hopper 15, which is loaded with the powder-loaded impact media m or a powder and the powder-loaded impact media m and has a bottom opening 15a communicated with the opening 10d, is disposed on the top plate 10c.

An opening 10e is formed in the other side plate facing the side plate 10b. An impact media-receiving container 16 is disposed below the opening 10e. A guide member 17 is provided in an appropriate part such as in a bottom plate 10a of the impact media storing box 10 so that the impact media-receiving container 16 receives the impact media m discharged from the opening 10e without spillage.

Additionally, the backside of the top plate 10c located near the side plates 10b and 10e of the impact media storing box 10 is provided with platy scrapers 18 being parallel to the side plates 10b and 10e. A prescribed clearance is formed between the scrapers 18 and the bottom plate 10a of the impact media storing box 10. The number of scrapers 18 is not necessarily two, but one of them may be omitted.

A case 19 is shown as an example of the article of this invention on which a coating is formed. An article holder 20 made of a sponge, soft formed resin or the like, which is to be fitted into the case 19, is attached to the backside of a lid 21 with fixing parts such as screws 22. The lid 21 to which the case 19 is attached through the article holder 20 covers an opening lOf of the impact media storing box 10 so that the case 19 attached to the lid 21 is disposed between the scrapers 18.

The magnet reciprocation device M is so arranged that the impact media storing box 10 disposed in the space formed by the pair of magnet-holding frames 7 does not contact the magnet-holding frames 7.

The impact media m in the present invention are made of a magnetic material such as iron, carbon steel, other alloyed steel, or an oxide ferrimagnetic material such as ferrite. The size of the impact media can be varied as long as they are allowed to enter holes, recesses or corners formed in the article. The shape of the impact media is not limited to spherical, but can be such various shapes as cubic, trigometric, cylindrical, conical, trigometric prism, pyramid, and rhombohedral. The impact media can be made entirely of a magnetic material or can be a mixture or compound partly including a magnetic material such as the ones thinly coated with a rubber material or soft synthetic resin material, and the ones that are made by mixing a magnetic powder with a resin.

An adhesive layer is formed on both the impact media m comprising a magnetic material and the case 19 as an example of the article to be coated. The liquid material to form an adhesive layer can be a one-liquid or two-liquid mixing type thermosetting resin such as melamine resin, epoxy resin, phenol resin, furan resin, urethane resin, unsaturated polyester resin, or a thermoplastic resin such as acrylic resin, polyester resin, polyethylene resin, polyvinyl alcohol, polypropylene, or liquid prepolymer or monomer of such resins. Also, inorganic adhesive materials such as water glass can be used for formation of the adhesive layer.

In the apparatus for forming a coating constructed as above, the motor 14 is driven and the cylinder 6 constituting the magnet reciprocation device M is operated to move the piston rod 6a back and forth so that the pair of magnet-holding frames 7 provided with magnet pieces 8 reciprocate along the rails 3. Then, the powder-loaded impact media m having been preliminarily stored in the impact media storing box 10 or being supplied from the hopper 15 into the storing box 10 are subjected to a magnetic field formed by the magnet pieces 8 in which those magnetic pieces located above the impact media m and those located below the impact media m are magnetized oppositely to each other, and thus form a magnetic brush B in which particles of the impact media are vertically aligned in strands. The impact media m forming the magnetic brush B move together with the movement of the magnet-holding frames 7, and collide with the case 19 being vibrated by the driving of the motor 14, when the powder applied to the impact media m is transferred to the case 19 so as to adhere thereto. At this stage, by moving the magnet-holding frames 7 beyond the scrapers 18, the impact media m forming a magnetic brush fall after collision with the scrapers 18 and the magnetic pieces 8 that return between the scrapers 18 again work to form a magnetic brush B, the transformation of the powder to the case 19 is thus promoted.

By driving the motor 14 to vibrate the impact media storing box 10, the impact media m supplied from the hopper 15 and stored in the storing box 10 move from the hopper 15 toward the side plate 10e, and are poured into the impact media-receiving container 16 through the opening 10e formed in the side plate 10e. The impact media m accepted in the receiving-container 16 are again supplied into the hopper 15 or cleansed for forming a new adhesive layer thereon. The hopper 15 can be preliminarily loaded with a necessary amount of the impact media m and powder. It is also possible to provide a belt conveyer for carrying the impact media and powder above the hopper 15 and powder so as to supply the impact media and powder sequentially into the hopper 15.

The powder that has been applied to the case 19 having an adhesive layer in its surface directly or being mediated by the impact media m is impinged by the impact media so that the adhesive layer covered with the powder is squeezed out onto the surface of the powder. The powder sticking directly to the adhesive layer that has been squeezed out and the powder applied to the impact media are transferred to the adhesive layer of the case 19 by the impingement of the impact media against the case 19. Thus, the adhesion of the powder to the case 19 proceeds. The process of powder adhesion i.e., the coating-formation process substantially completes when the adhesive layer is no longer squeezed out despite the impingement by the impact media m. The coating formation process can also be completed by stopping the driving of the coating formation apparatus before the adhesive layer stops being squeezed out.

As discussed above, the impact media m forming the magnetic brush B impinge against the case 19 vibrating due to the driving of the motor 14 so that the powder applied to the impact media m is transferred to the case 19. Without the vibration of the case 19 by the driving of the motor 14, the resultant powder coating formed on the case 19 will have linear marks caused by the magnetic brush B. Accordingly, the case 19 should preferably be vibrated by the driving of the motor 14. Also, when the vibration is not applied to the case 19, the impact media m do not move toward the side plate 10e, and accordingly, the magnetic brush B is formed by the same impact media m, causing the powder applied to the impact media m to be consumed faster. In such a case, the coating formation process will take a long time or the impact media m having running out of the powder will strip off the powder coating that has been formed on the case 19.

The case 19 on which a powder coating has been formed is subsequently subjected to a heat treatment in which the components of the adhesive layer are evaporated or cured so as to obtain the case 19 with a permanent powder coating.

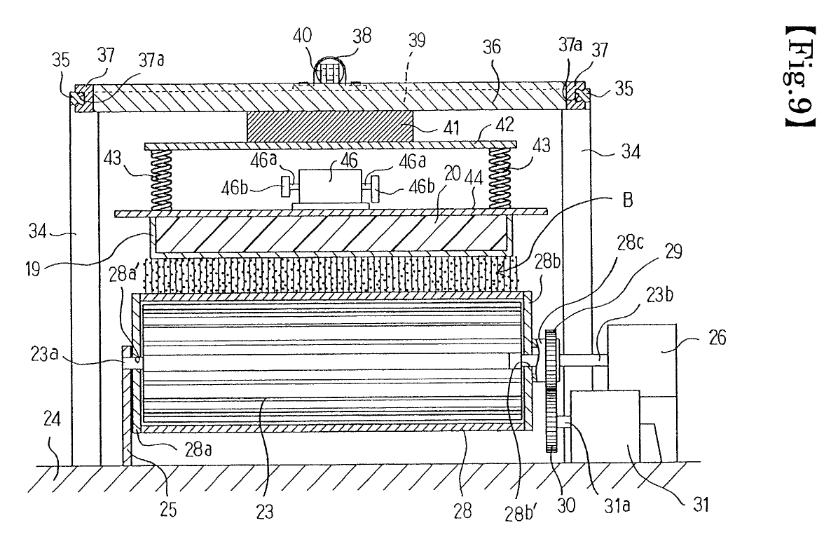

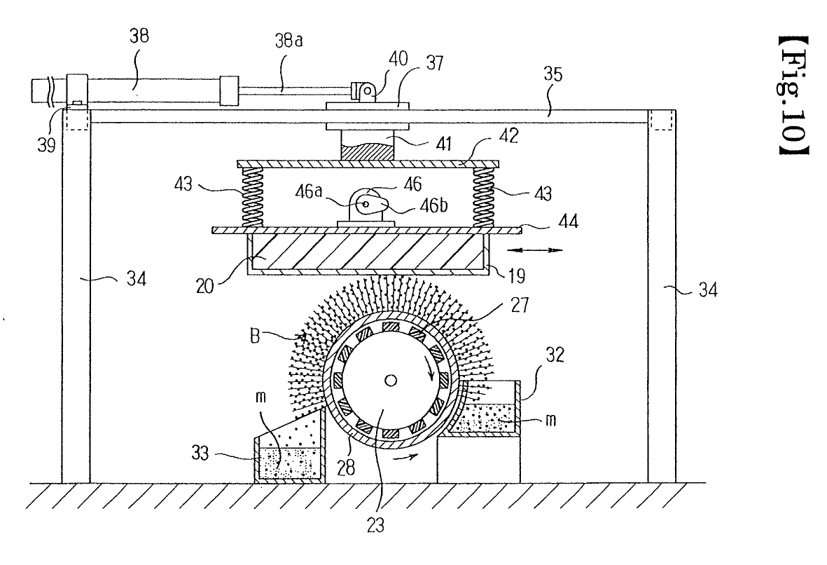

Referring to FIGS. 9 and 10, another embodiment of the apparatus for forming a coating according to the present invention is described.

A shaft 23a is mounted on one side surface of a columnar body 23 made of a magnetic material being rotatably supported by a support pillar 25 standing on a base 24. A shaft 23b mounted on the other side surface of the columnar body 23 constitutes a driving shaft of a motor 26. A plurality of strip-shaped magnets 27 is mounted on the columnar body 23 in the axial direction of the columnar body 23 at prescribed intervals. The magnets 27 are magnetized so that the upper sides have opposite poles to those of bottom sides. FIG. 10 shows the columnar body 23 rotating clockwise by the motor 26.

A cylindrical member 28 made of a non-magnetic material such as aluminum is disposed coaxially with the columnar body 23 in a manner to enclose the columnar body 23. One side of the cylindrical member 28 is supported by inserting the shaft 23a attached to the side into a through-hole 28a drilled in the center of the side wall 28a. A cylindrical body 28c is mounted on the central part of the other side wall 28b of the cylindrical member 28, and a spur gear 29 is mounted on the cylindrical body 28c. A spur gear 30 fitted to the spur gear 29 is mounted on a drive shaft 31a of a motor 31. A shaft 23b of the columnar body 23 being inserted into a through-hole 28b drilled in the other side of the side wall 28b of the cylindrical member 28 penetrates and extends from the cylindrical body 28c. The columnar body 23 and the cylindrical member 28 are arranged in such a manner that they rotate oppositely to each other and the columnar body 23 rotates faster than the cylindrical member 28. In this embodiment, the columnar body 23 is driven by the motor 26 to rotate clockwise, and accordingly, the cylindrical member 28 rotates counterclockwise driven by the motor 31 through the spur gears 29 and 30.

An impact media-storing box 32 that stores the impact media m made of a magnetic material is disposed adjacent to the cylindrical member 28. An impact media-receiving container 33 is located adjacent to the cylindrical member 28 and opposite to the coating-forming storing box 32.

A base 24 is provided with four support pillars 34 in a standing manner. A pair of such support pillars disposed transverse to the axis line of the cylindrical member 28 has a horizontal rail 35 mounted thereon. A slidable block 36 has rail engagement blocks 37 provided in its both sides, and the rail engagement blocks 37 are provided with recessed portion 37a to be engaged with the rail 35. A cylinder 38 is mounted on a horizontal frame 39, which is parallel to the axis line of the cylindrical member 28 and connects the pair of support pillars 34. A piston rod 38a of the cylinder 38 is supported in a pivotal manner by a lock tool 40 mounted on the slidable block 36.

A connector block 41 is attached to the bottom surface of the slidable block 36 with an upper plate member 42 attached thereto. Each of four coil springs 43 is connected to each of four corners of the bottom surface of the upper plate member 42. A lower plate member 44 is connected to the lower ends of the coil springs 43, and a case 19 with an adhesive layer formed thereon is fitted into the above mentioned article holder 20 attached to the bottom surface of the lower plate member 44. A motor 46 having output shafts 46a protruding from its both ends and having eccentric weights thereon is mounted on the upper surface of the lower plate member 44. The case 19 is disposed above the cylindrical member 28 and the columnar body 23 with strip-shaped magnets thereon.

In the apparatus for forming a coating constructed as above, the motor 46 is driven to move the cylinder 38 so as to reciprocate the piston rod 38a, according to which the slidable block 36 reciprocates along the rails 35 so that the case 19 held by the article holder 20 through the connector block 41, the upper plate member 42, the coil springs 43 and the lower plate member 44 reciprocate along the rails 35. Due to the magnetic force of the strip-shaped magnets 27 mounted on the columnar body 23, a magnetic brush B is formed radially on the surface of the cylindrical member 28. The magnetic brush B formed on the cylindrical member 28 moves in the direction of the impact media-receiving container 33 by the counterclockwise rotation of the cylindrical member 28. The impact media m forming the magnetic brush B are sequentially supplied from the impact media-storing container 32 and accepted in the impact media-receiving container 33. The impact media forming the magnetic brush B collide with the case 19 reciprocating along the rails 35 so that the powder applied to the impact media is transferred to the case 19 and attached thereto.

The powder that has been applied to the case 19 having an adhesive layer in its surface is impinged by the impact media m so that the powder is pressed against or pressed into the adhesive layer and firmly bonded thereto, as well as the adhesive layer covered with the powder is squeezed out onto the surface of the powder. The powder sticking directly to the adhesive layer that has been squeezed out and the powder adhering to the impact media are transferred to the adhesive layer of the case 19 by impingement of the impact media against the case 19. Thus, the adhesion of the powder to the case 19 proceeds. The process of powder adhesion i.e., the coating-formation process substantially completes when the adhesive layer is no longer squeezed out despite the impingement by the impact media m. The coating formation process can also be completed by stopping the driving of the coating formation apparatus before the adhesive layer stops being squeezed out.

The case 19 on which a powder coating has been formed is subsequently subjected to a heat treatment in which the components of the adhesive layer are evaporated or cured so as to obtain the case 19 with a permanent powder coating.

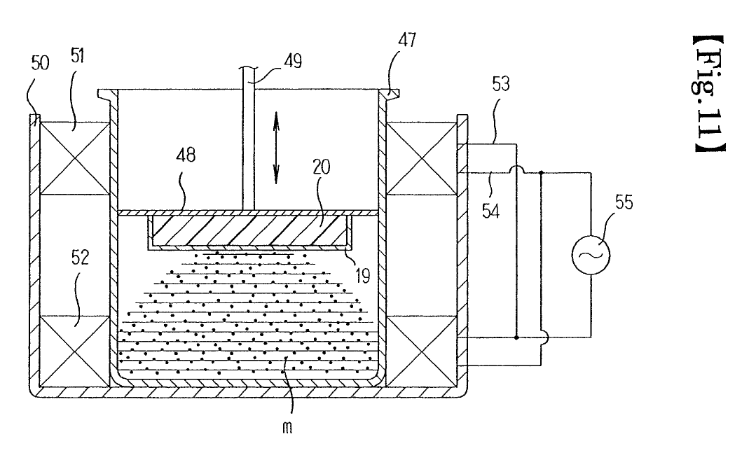

Referring to FIG. 11, still another embodiment of the apparatus for forming a coating for carrying out the coating method of the present invention is now described.

Impact media m are stored in a impact media-storing container 47 made of a magnetic material. An inner cover 48 is enclosed in the impact media-storing container 47 and attached to a piston rod 49 of a vertical cylinder not shown in the Figure. An article holder 20 attached to the bottom surface of the inner cover 48 is fit into a case 19 that is an example of the article to be coated.

An outer container 50 made of a non-magnetic material is disposed outside the impact media-storing container 47. An upper electromagnetic coil 51 and a lower electromagnetic coil 52 are located in a space formed between the impact media-storing container 47 and the outer container 50. The coils 51 and 52 are connected to a pair of connect wires 53 and 54 being connected to an AC powder supply 55.

When the AC power supply is energized, the upper electromagnetic coil and the lower electromagnetic coil 52 are alternately magnetized to the N pole and the S pole so that the impact media m made of a magnetic material stored in the impact media-storing container 47 move up and down to impinge against the case 19 with an adhesive layer formed in the surface. By this impingement of the powder-loaded impact media m, the powder that has been applied to the case 19 with the adhesive layer is struck by the impact media m so as to be pressed against or pressed into the adhesive layer and firmly bonded thereto. At the same time, the adhesive layer covered with the powder is squeezed out onto the surface of the powder by the impingement. The powder sticking directly to the adhesive layer that has been squeezed out and the powder applied to the impact media are transferred to the adhesive layer of the case 19. Thus, the adhesion of the powder to the case 19 proceeds. The process of powder adhesion i.e., the coating-formation process substantially completes when the adhesive layer is no longer squeezed out despite the impingement by the impact media m. The coating formation process can also be completed by stopping the driving of the coating formation apparatus before the adhesive layer stops being squeezed out.

The case 19 on which a powder coating has been formed is subsequently subjected to a heat treatment in which the components of the adhesive layer are evaporated or cured so as to obtain the case 19 with a permanent powder coating.

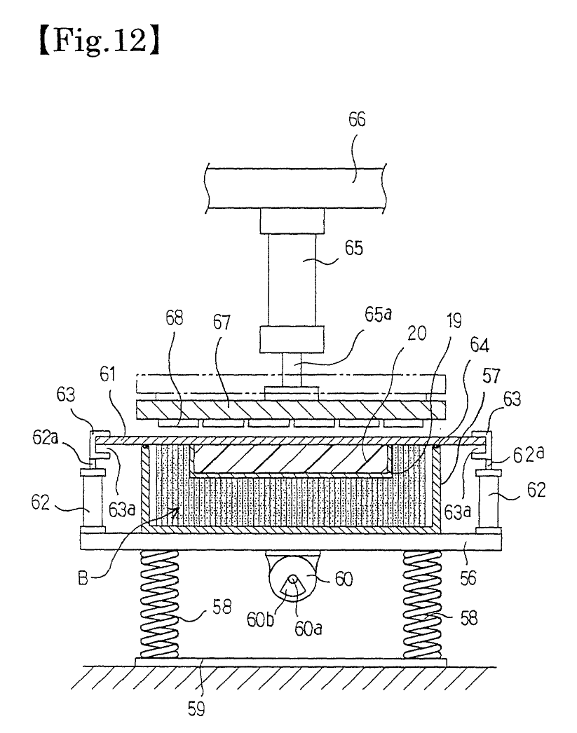

Referring to FIG. 12, another modification of the apparatus for forming a coating for carrying out the coating method of the present invention is now described.

A box-shaped impact media-storing container 57 is placed on a container loading plate 56. Coil springs 58 are disposed at four corners of the backside of the plate 56. The lower ends of the coil springs 58 are connected to a base member such as a base 59. A motor 60 is disposed in a central part of the bottom surface of the container loading plate 56. Eccentric weights 60b are mounted on an output shafts 60a of the motor 60 that is driven to rotate the eccentric weights 60b so as to vibrate the container loading plate 56.

The opening of the impact media-storing container 57 is covered with a lid 61 to whose backside the article holder 20 mentioned above is attached. The article holder 20 is fitted into a case 19 as an article to be coated.

A pair of vertical cylinders 62 whose rear ends are mounted on the container loading plate 56 is disposed in a manner to sandwich the impact media-storing container 57. Lid-holding members 63 having recessed portions 63a into which the both ends of the lid 61 are fitted are connected to piston rods 62a of the vertical cylinders 62. A packing 64 is shown, which is engaged into a groove formed in the upper end of the impact media-storing container 57. Both ends of the lid 61 are inserted into the recessed portions 63a of the lid-holding members 63 with the piston rods 62a in an advanced condition. Subsequently, the vertical cylinders 62 are driven to retract the piston rods 62a so that the lid-holding members 63 descend holding the lid 61. The lid 61 to whose backside the case 19 is attached through the article holder 20 thus covers the opening of the impact media-storing container 57.

A vertical cylinder 65 arranged in such a manner that its lower end portion is located above the container loading plate 56 is hung from a frame 66. A magnet-holding block 67 is horizontally attached to the end of a piston rod 65a of the vertical cylinder 65. Magnet pieces 68 similar to the above mentioned magnet pieces 8 are attached to the backside of the magnet holding block 67 at prescribed intervals, and arranged so as to at least extend beyond the case 19 as an article to be coated, in which every magnet piece is oriented in the same polar direction, for example, every bottom surface of the magnetic pieces is polarized with a N pole.

When the motor 60 is driven to vibrate the container loading plate 56, impact media-storing container 57 and the case 19 in contact with the lid 61 through the article holder 20, the powder-loaded impact media m forming a magnetic brush B due to the magnetic force of the magnet pieces 68 impinge against the case 19 on whose surface an adhesive layer has been formed. The powder that has been applied to the case 19 having an adhesive layer in its surface is impinged by the powder-loaded impact media m so that the powder is pressed against or pressed into the adhesive layer and firmly bonded thereto, as well as the adhesive layer covered with the powder is squeezed out onto the surface of the powder. The powder sticking directly to the adhesive layer that has been squeezed out and the powder applied to the impact media are transferred to the adhesive layer of the case 19 by the impingement of the impact media against the case 19. Thus, the adhesion of the powder to the case 19 proceeds. The process of powder adhesion i.e., the coating-formation process substantially completes when the adhesive layer is no longer squeezed out despite the impingement by the impact media m. The coating formation process can also be completed by stopping the driving of the coating formation apparatus before the adhesive layer stops being squeezed out.

The case 19 on which a powder coating has been formed is subsequently subjected to a heat treatment in which the components of the adhesive layer are evaporated or cured so as to obtain the case 19 with a permanent powder coating.

In the powder coating forming process described above, when the vertical cylinder 65 is driven to lift the piston rod 65a so as to move the magnet pieces 68 attached to the magnet holding block 67 apart from the impact media-storing container 57, the impact media m is located out of the influence of the magnetic force of the magnet pieces 68 and the magnetic brush B temporarily disappears. Then, the vertical cylinder 65 is driven again to lower the piston rod 65a so as to bring the magnet pieces 68 attached to the magnet holding block 67 close to the impact media-storing container 57, when a magnetic brush B is formed by new impact media m. By bringing the magnetic brush B formed by the new impact media in contact with the case 19, the transference of the powder to the case 19 is promoted.

An important aspect of the present invention described in the embodiments above is that the impact media, which serve as media for applying a powder to an article, comprises a magnetic material and are subjected to a magnetic field. When a magnetic field is applied to such impact media made of a magnetic material, plural particles of the impact media connect with one another in a beaded manner, thereby forming a magnetic brush. Due to the beads-like connection of a plurality of the impact media particles, even if some of the impact media are caught in small or deep holes or acute corners in an article having such holes or corners, the captured particles of the impact media can be attracted by the magnetic force of impact media particles adjoining the captured impact media particles so as to be ejected from such holes and corners. The impact media are thus prevented from being caught in small or deep holes or acute corners of an article, whereby the problem that the conventional methods suffer can be solved.

With the constitution stated above, the present invention has the following effects.

Even if the article to be coated has small or deep holes or acute corners and some of the impact media are caught in such holes or corners, the captured particles of the impact media can be attracted by the magnetic force of impact media particles adjoining the captured impact media particles so as to be ejected from such holes and corners. The impact media are thus prevented from being caught in small or deep holes or acute corners formed in an article, whereby the problem that the conventional methods suffer can be remedied.

Also, the method of this invention has enabled downsizing of the apparatus for coating articles with a large area such as cases for electronic devices.

What is claimed is:

1. A method for forming a powder coating on a surface of an article, in which impact media being covered with a powder impinge against the article with an adhesive layer formed thereon, whereby the powder is bonded to the surface of the article, characterized in that said impact media comprise a magnetic material and are subject to a magnetic field.

2. The method for forming a powder coating on a surface of an article according to claim 1, wherein said impact media comprising a magnetic material form a magnetic brush.

3. An apparatus for forming a coating on a surface of an article comprising an article with an adhesive layer formed thereon, impact media comprising a magnetic material being covered with a powder, means for moving either one or both of the article and the impact media, and means for applying a magnetic field to the impact media.
